(19) United States
(12) Patent Application Publication
(10) Pub. No.: US 2002/0174724 A1
(43) Pub. Date: Nov. 28, 2002

(54) Micromechanical component

(76) Inventors: Hubert Benzel, Pliezhausen (DE); Heribert Weber, Nuertingen (DE); Frank Schaefer, Tuebingen (DE)

Correspondence Address: KENYON & KENYON, ONE BROADWAY, NEW YORK, NY, 10004, US

(21) Appl. No.: 10/029,443

(22) Filed: Dec. 20, 2001

(30) Foreign Application Priority Data
Dec. 23, 2000 (DE) 1 00 65 025.2-33

(51) Int. Cl. G01L 1/00

(52) U.S. Cl. 73/763

(57) ABSTRACT

A micromechanical component, in particular a mass flow sensor, includes a tongue made of a micromechanical material that is elastically bendable under the influence of an external pressure acting on a surface region of the tongue, in which a piezoresistive resistance device is provided on the elastic tongue, in which a holding device holds a region of the elastic tongue, and in which the holding device is arranged so that the external pressure causes a change in the mechanical stress at the location of the tongue in the region of the piezoresistive resistance device.

### FIELD OF THE INVENTION

The present invention relates to a micromechanical component, in particular a mass flow sensor. Although applicable to any desired micromechanical components and structures, in particular sensors and actuators, the present invention and the problem which it is believed to address are described with respect to a mass flow sensor manufacturable by the technology of silicon micromechanics.

### BACKGROUND INFORMATION

Mass flow sensors may be used to detect a gas flow rate in a certain flow channel, e.g., the flow rate of the fuel-air mixture in the intake connection of an internal combustion engine in a motor vehicle.

Mass flow sensors may be mostly manufactured in bulk silicon micromechanics, and may have the disadvantage that they are expensive and complicated to manufacture.

### SUMMARY OF THE INVENTION

The exemplary micromechanical component according to the present invention is believed to have the advantage that it may be more easily and inexpensively manufactured than other available comparable components, such as mass flow sensors.

Other advantages of the exemplary micromechanical component according to the present invention are believed to include its very robust design, i.e., its lack of sensitivity to damage, in particular due to particle bombardment. An analyzer circuit may also be integrated into the same chip, e.g., in the supported region of the tongue.

A tongue made of a micromechanical material, such as silicon, is elastically bendable under the influence of an external pressure acting on a surface area of the tongue. A holding device, which is provided for holding a region of the elastic tongue, is arranged so that the external pressure causes a bending or a change in the mechanical stress at the location of the tongue, e.g., in the area of a piezoresistive resistance device or some other stress detecting device.

In the case of a mass flow sensor, the tongue protrudes into the mass flow and is bent by the prevailing dynamic pressure there. This elastic bending is measured in the bending region by piezoresistive resistors and converted to a corresponding mass flow by a corresponding analyzer circuit.

According to an exemplary embodiment, the stress detecting device has a piezoresistive resistance device.

According to another exemplary embodiment, a detecting device is provided for detecting the change in resistance of the piezoresistive resistance device caused by the change in mechanical stress. The direction of flow may be determined by the sign of the change in resistance.

According to another exemplary embodiment, the tongue has a bending line beneath which it is supported, and the piezoresistive resistance device has one or more resistance strips extending over the bending line.

According to another exemplary embodiment, the tongue has an essentially rectangular shape in sections.

According to another exemplary embodiment, the tongue has recesses along the bending lines.

According to another exemplary embodiment, the tongue has notches along the bending lines on the side facing away from the piezoresistive resistance device.

According to another exemplary embodiment, the supported region of the tongue has one or more recesses for securing it.

According to another exemplary embodiment, the tongue is arranged in one piece having a frame which determines the region of the acting external pressure and the flow around the tongue.

According to another exemplary embodiment, the tongue is reinforced by a supporting substrate in the supported region.

According to another exemplary embodiment, the micromechanical component is installed in a flow channel, with the piezoresistive resistance device being provided on the side facing away from the direction of flow.

### BRIEF DESCRIPTION OF THE DRAWINGS

FIG. 1a shows a schematic block diagram of a mass flow sensor according to a first exemplary embodiment of the present invention, including a top view of the sensor tongue.

FIG. 1b shows a schematic block diagram of a mass flow sensor according to a first exemplary embodiment of the present invention, including a perspective view of the sensor tongue installed in a flow channel.

FIG. 2 shows a schematic block diagram of a top view of the sensor tongue of a mass flow sensor according to a second exemplary embodiment of the present invention.

FIG. 3a shows a schematic block diagram of a cross-sectional view of the sensor tongue of a mass flow sensor according to a third exemplary embodiment of the present invention.

FIG. 3b shows a schematic block diagram of a cross-sectional view of the sensor tongue of a mass flow sensor according to a fourth exemplary embodiment of the present invention.

FIG. 3c shows a schematic block diagram of a cross-sectional view of the sensor tongue of a mass flow sensor according to a fifth exemplary embodiment of the present invention.

FIG. 4 shows a schematic block diagram of a top view of the sensor tongue of a mass flow sensor according to a sixth exemplary embodiment of the present invention.

FIG. 5 shows a schematic block diagram of a top view of the sensor tongue of a mass flow sensor according to a seventh exemplary embodiment of the present invention.

FIG. 6 shows a schematic block diagram of a top view of the sensor tongue of a mass flow sensor according to an eighth exemplary embodiment of the present invention.

FIG. 7 shows a schematic block diagram of a top view of the sensor tongue of a mass flow sensor according to a ninth exemplary embodiment of the present invention.

FIG. 8 shows a schematic block diagram of a cross-sectional view of the sensor tongue of a mass flow sensor according to a tenth exemplary embodiment of the present invention.

### DETAILED DESCRIPTION

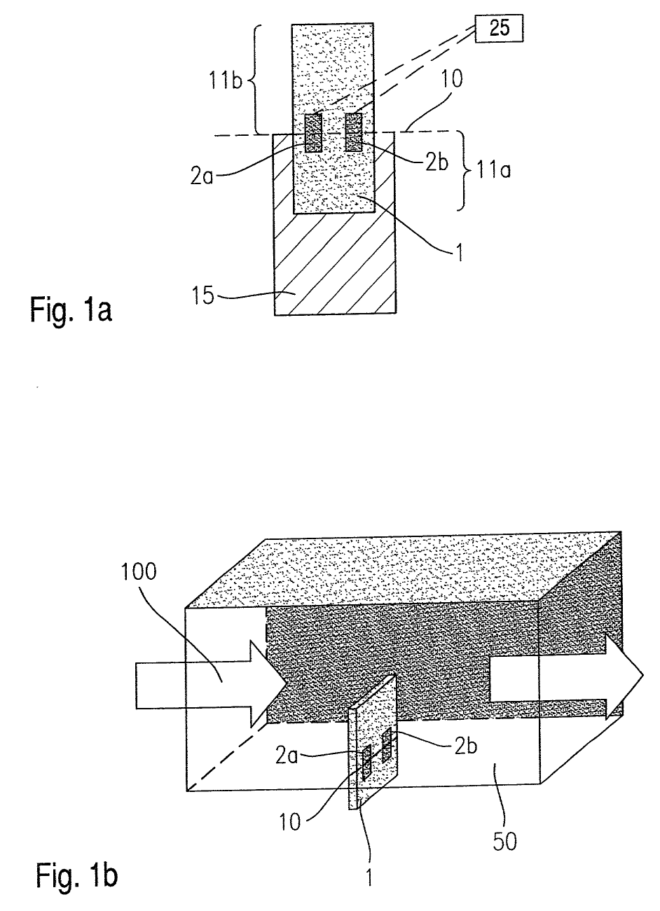

FIGS. 1a, b show a schematic block diagram of a mass flow sensor according to a first exemplary embodiment of the present invention. Specifically, FIG. 1a shows a top view of the sensor tongue, and FIG. 1b shows a perspective view of a sensor tongue installed in a flow channel.

FIGS. 1a, b show a tongue 1 made of silicon, piezoresistive resistance strips 2a, 2b introduced into tongue 1, a bending line 10, which is elastically bendable along tongue 1 under the influence of an external pressure, a clamped region 11a of tongue 1, a bendable free region lib of tongue 1, a supporting device or a clamping device 15 for holding region 11a of tongue 1 and a detecting device 25, which may be integrated on tongue 1 or provided outside of tongue 1.

Tongue 1 shown in FIG. 1a includes a rectangular piece of silicon having the same thickness everywhere. Piezoresistive resistors 2a, 2b extend as conductors over bending line 10, so that bending of the tongue due to an external pressure causes deformation of piezoresistive resistors 2a, 2b and thus causes a change in resistance.

According to FIG. 1b, tongue 1 is installed in a flow channel 50 according to FIG. 1a, where 100 denotes the direction of flow of a gas, e.g., a fuel mixture. Due to the special type of support or clamping by supporting device 15, which is not shown in FIG. 1b, the maximum bending occurs along bending lines 1, and therefore a maximum change in the resistance of piezoresistive resistors 2a, 2b is achieved. Detecting device 25, also shown in FIG. 1a, processes these changes in resistance and determines the mass flow of the gas in direction of flow 100 in flow channel 50, optionally after proper calibration.

In the built-in variant according to FIG. 1b, piezoresistive resistors 2a, 2b are implemented on the side facing away from the mass flow. They are therefore protected from particle bombardment.

With gases, this change in resistance is a linear function of the mass flow, but with liquids it is a square function. For example, with a silicon tongue 1 having a thickness of 400 μm, a width and a height of 2 mm projecting into the flow channel, the change in resistance is large enough to permit reliable analysis.

Thus, in the simplest variant, tongue 1 may be produced on a standard substrate through a few process steps and then cutting. The stress at the location or the bending along bending lines 10 and thus the change in resistance depend on the reciprocal of the thickness of tongue 1 by a square function, i.e., to increase the detection sensitivity, the tongue should be designed to be as thin as possible along bending lines 10. This is limited by the technical feasibility and by the stability of tongue 1. The greater the reversible bending possible along bending lines 10, the greater the sensitivity of the respective sensor.

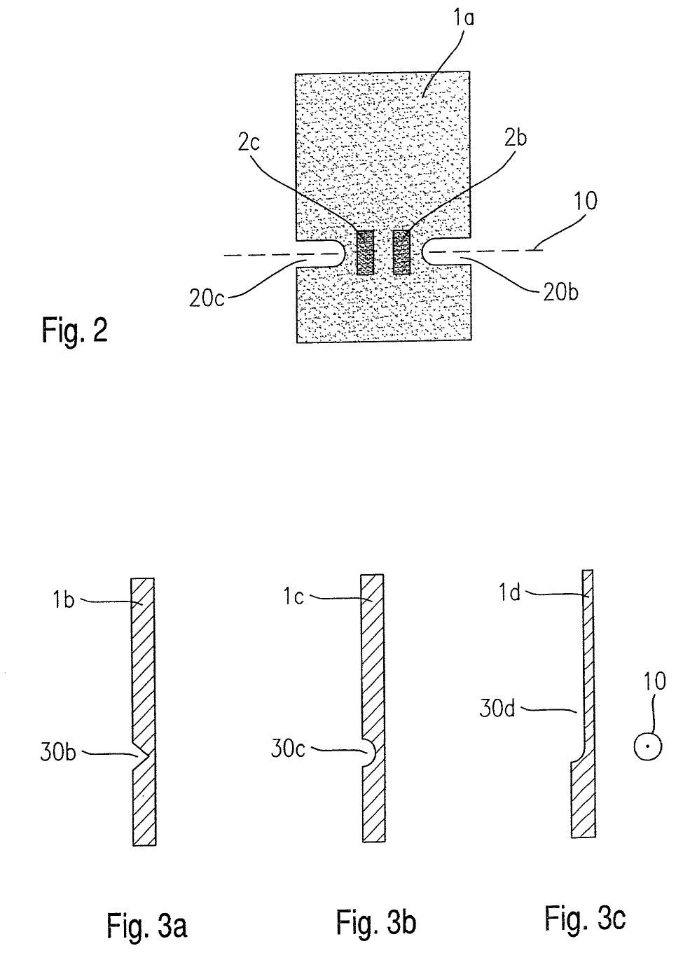

FIG. 2 shows a schematic block diagram of a top view of the sensor tongue of a mass flow sensor according to a second exemplary embodiment of the present invention.

In this second exemplary embodiment according to FIG. 2, lateral recesses 20a, 20b are provided on both sides of tongue 1a along bending lines 10. Tongue 1a is thus more easily bendable in the region of bending lines 10 and therefore the respective sensor is more sensitive. These lateral recesses 20a, 20b are easily produced by etching. For example, available high-rate trenching may be used as the etching technique for this. In addition, it is possible to accurately position tongue 1a in a housing and secure it there through the location of the recesses. This accurately secures their position in flow channel 50.

FIGS. 3a, 3b, and 3c show a schematic block diagram of a cross-sectional view of the sensor tongue of a mass flow sensor according to respective third, fourth and fifth exemplary embodiments of the present invention.

FIGS. 3a through c show three variants in which notches 30b, 30c and 30d are provided on the side facing away from piezoresistive resistors 2a, 2b. These notches 30b, 30c, 30d may be produced by isotropic or anisotropic etching methods, where isotropic overetching is to be performed in manufacture with anisotropic etching techniques to prevent interfering notching effects which could result in tongue 1b, 1c or 1d breaking off.

According to FIGS. 3a and 3b, tongue 1a or 1b is notched locally, and according to FIG. 3c, the tongue is thinned over the entire region above bending lines 10. Of course, various notches in FIG. 3 may be combined. Due to such notches 30b, 30c, 30d, there is a concentration of the mechanical stresses in the region of piezoresistive resistors 2a, 2b, relatively independently of the clamping in the housing.

In other words, in these embodiments, the clamping need not be provided in the entire region beneath bending lines 10, as shown in FIG. 1a, but instead it may be limited to the bottom part of tongue 1a, 1b, 1c, because the maximum bending along bending lines 10 is automatically achieved due to the variable bendability over the length.

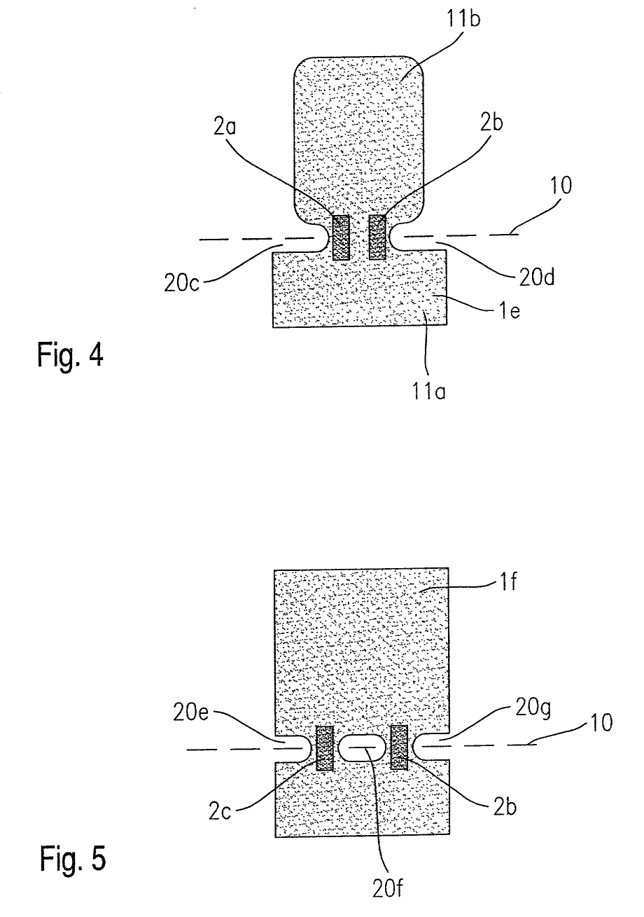

FIG. 4 shows a schematic block diagram of a top view of the sensor tongue of a mass flow sensor according to a sixth exemplary embodiment of the present invention.

If the dimensions of the tongue are determined primarily by cutting, then there is the risk that the edges of the tongue might be predamaged because of small cracks or pieces broken-off in cutting. This could reduce the stability of the silicon tongue and thus its lifetime. In the sixth exemplary embodiment according to FIG. 4, this may be prevented by defining the geometry of tongue le by etching techniques such as high-rate trenching rather than by cutting. The size definition of unsupported part 11b may thus also be specified more accurately. The sixth exemplary embodiment according to FIG. 4 may of course also be produced in conjunction with the notches according to the third through fifth embodiments.

FIG. 5 shows a schematic block diagram of a top view of the sensor tongue of a mass flow sensor according to a seventh exemplary embodiment of the present invention.

In the seventh exemplary embodiment according to FIG. 5, not only are lateral recesses 20e, 20g like 20a through 20d provided along the bending line, but also a central recess 20f, which is designed as a continuous hole. Therefore, the sensitivity along bending lines 10 may be further increased.

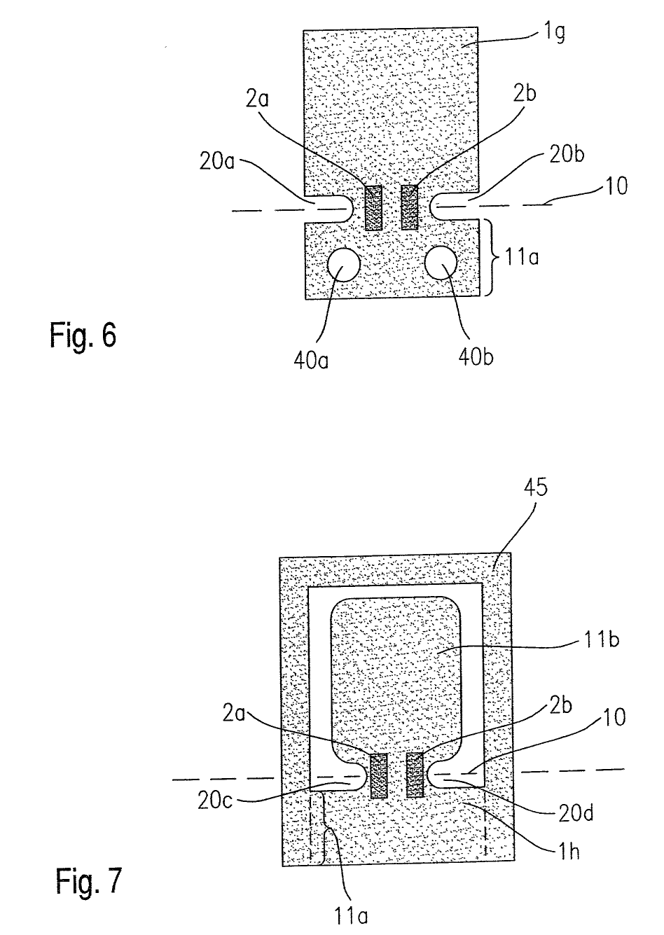

FIG. 6 shows a schematic block diagram of a top view of the sensor tongue of a mass flow sensor according to an eighth exemplary embodiment of the present invention.

In the eighth exemplary embodiment according to FIG. 6, recesses 40a, 40b are provided in clamped region 11a for securing to a housing (not shown). The number, location and shape may be selected almost as desired.

FIG. 7 shows a schematic block diagram of a top view of the sensor tongue of a mass flow sensor according to a ninth exemplary embodiment of the present invention.

In the ninth exemplary embodiment according to FIG. 7, tongue 1h in clamped region 11a is provided with a frame 45 in one piece with it, the frame determining the cross section of flow. This frame 45 may also be secured in the housing.

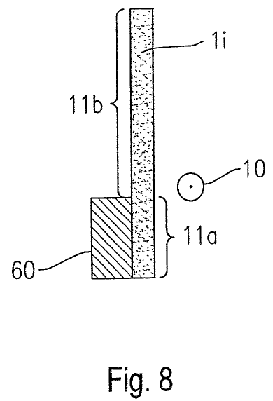

FIG. 8 shows a schematic block diagram of a cross-sectional view of the sensor tongue of a mass flow sensor according to a tenth exemplary embodiment of the present invention.

In the tenth exemplary embodiment according to FIG. 8, in clamped region 11a of tongue 1i, an additional reinforcement is provided by bonding a supporting substrate 60, e.g., a glass, which facilitates bending along bending lines 10.

The exemplary embodiments of the present invention may be applied not only to a mass flow sensor, but to any desired micromechanical components having an elastic tongue.

It is believed that all the exemplary embodiments described here may be combined and may be manufactured in one piece with an integrated circuit for analyses. This integrated circuit may be in region 11a of the silicon tongue, which is protected by the housing, i.e., is supported by it.

The number of piezoresistive resistors is not limited to two, but instead depends on the desired method of analysis. For example, four resistors may be connected in the manner of a Wheatstone measuring bridge.

Shapes which differ greatly from a rectangle or the other shapes shown here are of course may also be used as the shape of the tongue. The shape should be selected to be the best hydrodynamically.

Instead of the piezoresistive resistance device, wire strain gauges or the like may also be provided as the stress detecting device.

What is claimed is:

1. A micromechanical component comprising:
a tongue made of a micromechanical material that is elastically bendable under the influence of an external pressure acting on a first region of the tongue;
a stress detecting device provided on the elastic tongue; and
a holding device for holding a second region of the elastic tongue, wherein the holding device is arranged so that the external pressure causes a change in a mechanical stress at a location of the stress detecting device.

2. The micromechanical component of claim 1, wherein the stress detecting device includes a piezoresistive resistance device.

3. The micromechanical component of claim 2, wherein a detecting device is provided for detecting a change in resistance of the piezoresistive resistance device caused by the change in the mechanical stress.

4. The micromechanical component of claim 2, wherein the tongue includes a bending line beneath which it is supported, and the piezoresistive resistance device includes at least one resistance strip extending over the bending line.

5. The micromechanical component of claim 1, wherein the tongue has an essentially rectangular shape in sections.

6. The micromechanical component of claim 1, wherein the tongue includes recesses along the bending lines.

7. The micromechanical component of claim 2, wherein the tongue includes notches along the bending lines on a side facing away from the piezoresistive resistance device.

8. The micromechanical component of claim 1, wherein a supported second region of the tongue includes at least one recess to secure it.

9. The micromechanical component of claim 1, wherein the tongue is in one piece having a frame that determines a region of an acting external pressure and a flow around the tongue.

10. The micromechanical component of claim 1, wherein the tongue is reinforced by a supporting substrate in a supported second region of the tongue.

11. The micromechanical component of claim 2, wherein the micromechanical component is installed in a flow channel, and the piezoresistive resistance device is provided on a side facing away from a flow direction.

12. The micromechanical component of claim 1, wherein the micromechanical component includes a mass flow sensor.
